(19) United States
(12) Patent Application Publication
(10) Pub. No.: US 2021/0170629 A1
(43) Pub. Date: Jun. 10, 2021

(54) JEWEL, IN PARTICULAR FOR AN HOROLOGICAL MOVEMENT, AND MANUFACTURING METHOD THEREOF

(71) Applicant: Comadur SA, Le Locle (CH)

(72) Inventors: Bruno BESUTTI, Charquemont (FR); Sébastien RETROUVEY, Chissey sur Loue (FR)

(73) Assignee: Comadur SA, Le Locle (CH)

(21) Appl. No.: 17/099,015

(22) Filed: Nov. 16, 2020

(30) Foreign Application Priority Data
Dec. 10, 2019 (EP) 19214883.1

(51) Int. Cl. B28B 3/02; B28B 7/00; A44C 27/00; A44C 17/00

(52) U.S. Cl. CPC B28B 3/021; A44C 17/007; A44C 27/001; B28B 7/0097

(57) ABSTRACT

A method for manufacturing a jewel for a timepiece, the jewel including, for example, poly-ruby of the Al2O3Cr type or Zirconia of the ZrO2 type, including first producing a precursor and a then pressing the precursor in order to form a body, the pressing being carried out using a pressing device provided with an upper die and a lower die defining a pressing space wherein the precursor is disposed, the upper die including a concave portion of oblong shape, the device having a wire at least partially traversing the lower die to open into the pressing space, the lower die being able to slide around the wire, the pressing being carried out by bringing the lower die and the upper die closer together to form a body including an upper face provided with a dome and a lower face provided with a hole extending at least partially into the dome.

### CROSS-REFERENCE TO RELATED APPLICATIONS

This application claims priority to European Patent Application No. 19214883.1 filed Dec. 10, 2019, the entire contents of which are incorporated herein by reference.

### FIELD OF THE INVENTION

The invention relates to a method for manufacturing a jewel, in particular for an horological movement.

The invention also relates to a jewel, in particular of an horological movement, for example an industrial jewel or a technical ceramic.

The invention also relates to an horological movement including such a jewel.

The invention also relates to a pressing device for implementing the method.

### BACKGROUND OF THE INVENTION

In the prior art of watchmaking, ruby, ZrO2 or sapphire-type jewels are used in particular to form counter-pivots or guide elements, called bearings, in timepieces. These counter-pivots and guide elements are intended to be in contact with the pivots in order to make the latter movable in rotation, with minimal friction. Thus, they form, for example, all or part of a bearing of an axis mounted in rotation. The guide elements generally comprise a through hole for inserting the pivot pin therein.

FIG. 1 is a representation of a bearing 1 for a pivot 2 of a rotating mobile according to the prior art. The bearing 1 comprises a bearing block 3, wherein is arranged a guide element 4, which is here a jewel. The jewel includes a through hole 5 to receive the end 6 of the pivot 2. Thus, the pivot 2 can rotate in the hole 5.

Normally, synthetic industrial jewels are used in horological movements. In particular, the method of the Verneuil type is known for manufacturing monocrystalline-type jewels. There are also poly-crystalline-type jewels, which are made by pressing a precursor in order to obtain a green body of the future jewel from a pressing tool. The jewels are then sintered, machined to obtain a finished shape with the desired dimensions. In particular, concerning the guide elements made of poly-crystalline jewel, the pressing tool is for example provided with a wire participating in the construction of a hole blank.

However, these techniques for machining these poly-crystalline jewels do not allow small holes to be obtained. In particular, diameters of 0.11 mm can be reached, thanks to the usual techniques known today. But it is not possible to go below this value. In order to be able to go below, it is necessary to resort to laser technologies, which are difficult to implement industrially, and which do not directly provide a quality surface finish of the hole.

### SUMMARY OF THE INVENTION

The purpose of the present invention is to overcome all or part of the disadvantages mentioned above, by proposing a method for manufacturing a jewel on a large scale allowing the production of a very small diameter hole.

To this end, the invention relates to a method for manufacturing a poly-crystalline-type jewel, in particular for a timepiece, the jewel comprising, for example, poly-ruby of the Al2O3Cr type or Zirconia ceramic of the ZrO2 type, the method comprising a first step of producing a precursor.

The method is remarkable in that it comprises a second step of pressing the precursor in order to form a body, the pressing being carried out using a pressing device provided with an upper die and a lower die defining a pressing space wherein the precursor is disposed, the upper die comprising a concave portion of oblong shape, the device being provided with a wire at least partially traversing the lower die to open into the pressing space, the lower die being able to slide around the wire, the pressing being carried out by bringing the lower die and the upper die closer together to form a body comprising an upper face provided with a dome and a lower face provided with a hole extending at least partially into the dome.

Thus, this method allows to form green bodies which, after sintering and machining, will give jewels with a hole of very small diameter, in particular less than or equal to 0.1 mm. This method is further implemented by an easy-to-use pressing device, the pressing device used being an improvement of a conventional device for manufacturing a green body. The invention therefore allows to manufacture these jewels industrially on a large scale, without having to resort to systems that are expensive and complicated to be implemented.

According to a particular embodiment of the invention, the pressing step is carried out by displacing the lower die towards the upper die around the fixed wire.

According to a particular embodiment of the invention, during pressing, a circular recess is formed in the upper face of the body around the dome, the upper die being provided with a flange delimiting the concave portion.

According to a particular embodiment of the invention, the upper die displaces upwards under the effect of that of the lower die, the displacement of the upper die being less than that of the lower die.

According to a particular embodiment of the invention, the method comprises a third step of sintering said body in order to form the mineral body.

According to a particular embodiment of the invention, the method comprises a fourth machining step to remove an upper portion of the dome from the mineral body, in order to obtain a hole traversing the jewel.

According to a particular embodiment of the invention, the method comprises a fifth finishing step, for example a lapping and/or brushing and/or polishing of the mineral body.

The invention also relates to a jewel, in particular for an horological movement, formed from a poly-crystalline-type body and comprising, for example, poly-ruby of Al2O3Cr type or Zirconia of ZrO2 type, the body can be obtained by the method according to the invention. The jewel is remarkable in that the body comprises a lower face provided with a hole whose diameter is less than 0.11 mm, the jewel comprising a dome on the upper face, the hole partly extending into the dome.

According to a particular embodiment of the invention, the dome forms an angle comprised within an interval ranging from 30° to 90°, preferably from 50 to 70°, or even 60°.

According to a particular embodiment of the invention, the diameter of the hole is comprised within an interval ranging from 0.2 to 0.8 mm, or even from 0.4 to 0.6 mm.

According to a particular embodiment of the invention, the hole is a through hole, an upper portion of the dome being removed.

According to a particular embodiment of the invention, the upper face of the jewel comprises a circular recess arranged around the hole.

According to a particular embodiment of the invention, the jewel comprises a flare around the hole on its lower face.

The invention also relates to a timepiece comprising such a jewel, in particular for a balance bearing.

The invention also relates to a pressing device for the manufacture of a jewel, in particular for a timepiece, the device comprising a casing defining a housing, an upper die and a lower die configured to be able to displace in the housing, the dies defining a pressing space wherein a precursor can be disposed, the upper die comprising a flange, the device being provided with a wire at least partially traversing the lower die to open into the pressing space, the wire being fixed relative to the lower die and centred on the flange of the upper die, the lower die comprising an orifice for receiving the wire, the die being able to slide around the wire.

### BRIEF DESCRIPTION OF THE DRAWINGS

Other features and advantages will emerge clearly from the description which is given below, in an indicative and non-limiting manner, with reference to the appended drawings, wherein:

FIG. 1 is a schematic representation of a bearing for a pivot according to an embodiment known from the prior art;

FIG. 2 is a block diagram of a method for producing a jewel according to the invention;

FIG. 3 is a schematic representation of a portion of a pressing device according to the invention;

FIG. 4 is a schematic representation of the portion of FIG. 4 with the precursor;

FIG. 5 is a schematic representation of the pressing device according to the invention;

FIG. 6 is a schematic representation of the pressing device according to the invention during pressing;

FIG. 7 is a schematic representation of a green body obtained after the pressing step thanks to the method according to the invention;

FIG. 8 is a schematic representation of a mineral body obtained after part of the machining step thanks to the method according to the invention;

FIG. 9 is a schematic representation of a jewel obtained thanks to the method according to the invention;

FIG. 10 is a schematic representation of a system for manufacturing a jewel comprising a pressing device according to the invention.

### DETAILED DESCRIPTION OF THE PREFERRED EMBODIMENTS

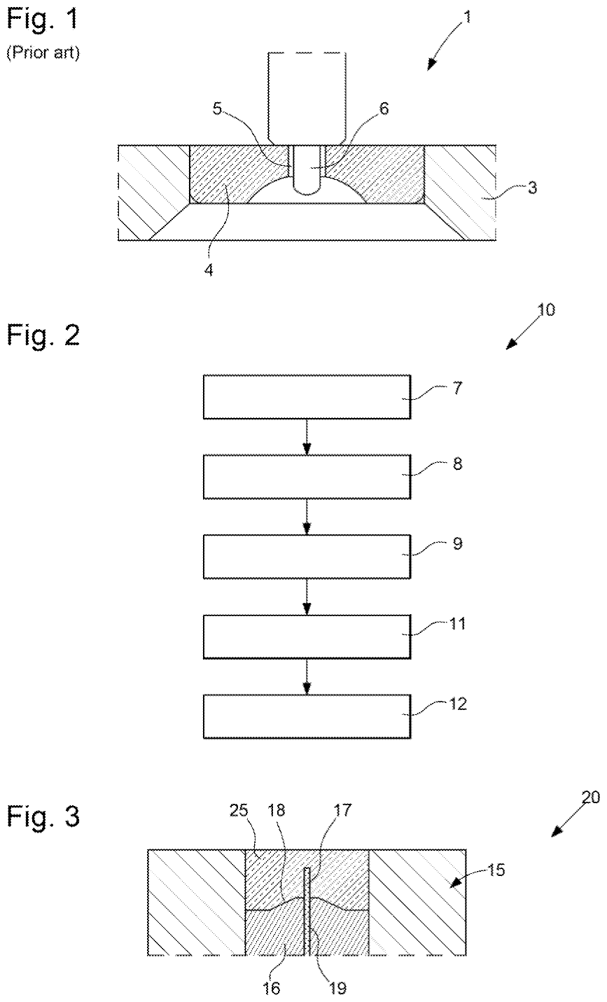

As explained above, the invention relates to a method for manufacturing a jewel capable of forming a guide element of a timepiece. The jewel is for example intended to be in contact with a pivot, also called a trunnion, for example of a balance axis, in order to make the latter movable in rotation with minimal friction. It is therefore understood that the present invention allows in particular to produce a jewel which can form all or part of a bearing of an axis mounted in rotation, such as that shown in FIG. 1.

The jewel is formed from a precursor, modelled as a green body, which becomes a mineral body of the poly-crystalline type for sapphire, the body comprising, for example, poly-ruby of the Al2O3Cr type or Zirconia ceramic of the ZrO2 type. The mineral body is cut to become the final jewel.

In the embodiment 5 of the method, shown in FIG. 2, such a method includes a first step 7 of producing a precursor from a mixture of at least one powder material with a binder. This material can be, in a non-limiting and non-exhaustive manner, ceramic. This step 7 is intended to form a precursor from a ceramic-based powder taken in the binder.

In this context, the ceramic-based powder can include at least one metal oxide, one metal nitride or one metal carbide. For example, the ceramic-based powder may include aluminium oxide in order to form synthetic sapphire or a mixture of aluminium oxide and chromium oxide in order to form synthetic ruby, or else zirconium oxide. In addition, the binder can be of various natures such as, for example, of polymeric types or of organic types.

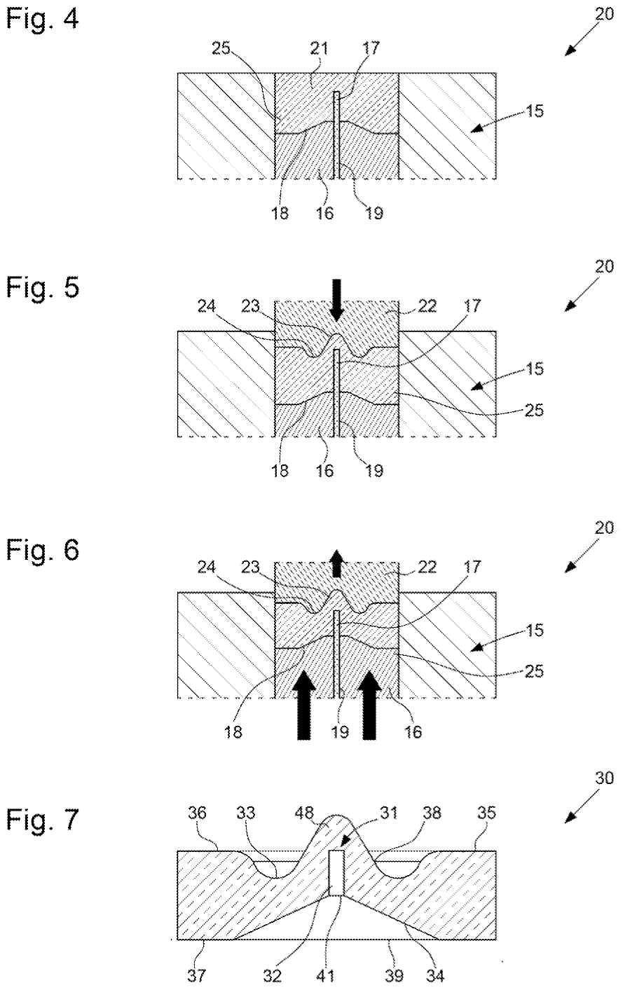

The embodiment then includes a second step of pressing 8 the precursor from an upper die and a lower die of a pressing device, to form a green body of the future jewel. The pressing step is shown in FIGS. 4 to 7, which are described later in the description. The pressing step 8 allows to obtain a green body provided with a dome and a hole extending at least partially inside the dome. It is therefore understood that the shape of the dome is provided by the concave portion 23 of the upper die 22, and the shape of the hole is provided by the shape of the wire 17 of the lower die 16 of the pressing device 20.

The method comprises a third step of sintering 9 said green body in order to form the mineral body of the future jewel in said at least one material.

The material can be, as mentioned previously, ceramic. In other words, this step 9 is intended to sinter the green body in order to form a ceramic body of the future pierced jewel. Preferably according to the invention, the sintering step 9 may include a pyrolysis, for example by thermal debinding.

The method 10 comprises a fourth machining step 11, in particular for removing a portion of the dome from the mineral body, in order to obtain a hole traversing the jewel. Machining involves planing the upper portion of the dome. Thus, by removing the upper portion, the hole is opened in the upper face of the green body to obtain a through hole. The machining step 11 also comprises a sub-step of shaping the upper face and the lower face to obtain a predefined jewel thickness.

The method comprises a fifth finishing step 12, for example a lapping and/or brushing and/or polishing of the mineral body. This finishing allows to give the jewel a surface state compatible with its use. Such a finishing step also allows the adjustment of the final dimensions and/or the removal of edges and/or the local modification of the roughness.

In FIGS. 3 to 6, the pressing device 20 comprises a casing 15 provided with a chamber, inside which an upper die 22 and a lower die 16 can slide. Each die 16, 22 is fixed on a double-acting press. The upper die 22 and the lower die 16 define a pressing space 25 wherein the precursor 21 is disposed.

In FIGS. 3 and 4, only the lower die 16 is shown. The device 10 is further provided with a wire 17 at least partially traversing the lower die 16 to open into the pressing space 25. The wire 17 is fixed relative to the lower die 16 and centred on the lower die 16. The lower die 16 comprises an orifice 19 for the passage of the wire 17. Thus, the lower die 16 slides around the wire 17. The wire 17 is therefore stationary relative to the lower die 16.

The lower die 16 is further provided with a domed portion 18, preferably of conical shape with a large opening angle, for example comprised within an interval ranging from 60° to 140°, preferably comprised between 90° and 120°. The domed portion 18 is centred on the lower die 16, so that the passage 19 and therefore the wire 17 are arranged at the top of the domed portion 18.

The precursor 21 is positioned in the pressing space 25, as shown in FIG. 4. Then, the upper die 22 is positioned in the housing on the precursor 21.

The upper die 22 comprises an oblong concave portion 23. The concave portion 23 is centred on the axis of the upper die 22. The concave portion 23 preferably has a conical shape with a circular base, the top of the cone defining the bottom of the concave portion 23. The bottom of the concave portion has for example a rounded shape. The cone has, for example, an opening angle comprised within an interval ranging from 30 to 90°, preferably from 50 to 70°, or even 60°.

The upper die 22 is further provided with a flange 24 delimiting the concave portion 23. The flange 24 is circular and preferably has a substantially rounded profile. Thus, during pressing, a circular recess is formed in the upper face of the green body around the concave portion. The minimum diameter of the flange 24 is greater than that of the circular base of the concave portion 23. Preferably, the minimum diameter corresponds to that of the circular base of the concave portion 23. Thus, the recess 33 formed in the upper face 36 borders the circumference of the concave portion 23. The internal wall 38 of the recess 33 forms the base of the concave portion 23.

The pressing 8 is carried out by bringing the upper die 22 and the lower die 16 closer together, so as to compress the precursor 21 in the pressing space 25. Preferably, the pressing 8 is carried out by displacing the lower die 16 towards the upper die 22 around the fixed wire 17. Thus, the precursor 21 is packed against the upper die 22 to give the green body a shape corresponding to the pressing space 25 once the two dies 16, 22 are brought closer together. The green body therefore takes the shape of the upper 22 and lower 16 dies for the upper 36 and lower 37 faces of the body.

Thus, such a pressing step 8 is intended to compress the precursor 21 in order to form the green body of the future pierced jewel with a dome on the upper face and a hole on the lower face.

Preferably, the upper die 22 displaces under the pressure effect of the lower die 16, the displacement of the upper die 22 being less than that of the lower die. Thus, the risk of breaking the wire 17 during pressing 8 is reduced.

FIG. 7 shows the green body 30 thus obtained. The green body 30 comprises an upper face 36 provided with a dome 31 and a recess 33 around the dome 31. The dome 31 preferably has a conical shape with a circular base corresponding to that of the concave portion 23 of the upper die 16. The dome 31 is prominent from the upper face 36. In other words, it extends at least partially beyond the rest of the upper face 36. Beyond the recess 33, the upper face 36 of the green body comprises a substantially planar circumferential surface 35, the height of which is less than that of the dome 31, but greater than the recess 33.

The green body 30 comprises a lower face 37 provided with a hole 32. The hole 32 was formed by the wire during pressing. The hole 32 has a cylindrical shape. The hole 32 has a depth selected so that it extends through the jewel at least partially in the dome 31. The depth is for example selected to go beyond the bottom of the recess 33, from the lower face 37. At this stage, the hole 32 is not a through hole, but includes a bottom disposed in the dome 31. Thanks to the method, a hole 32 is obtained with a very small diameter, which may in particular be less than 0.1 mm, or even less than 0.05 mm.

The lower face 37 of the green body 30 is provided with a flared portion 34, the flared portion 34 bordering the hole 32. The flared portion 34 has a conical shape. This flaring then forms a cone for engaging the pierced jewel 40. The cone 12 is preferably circular. The cone has a first opening 39 at its base and a second opening 41 at its top. The first opening 39 is larger than the second one 41, and is formed in the lower face 37 of the body 30. The connection of the cone 34 and the hole 32 is performed through the second opening 41 to form an edge. Thus, the flare 34 allows to easily insert the pivot of an axis of a part movable in rotation, in particular in the event of an impact. The angle of the cone is selected to prevent the edge formed by the top of the cone and the hole 8 from protruding too much. For example, an angle comprised between 60° and 140°, preferably comprised between 90° and 120°, is selected.

The green body 30, once formed, is subjected to the sintering step to obtain a mineral body, which maintains an identical shape.

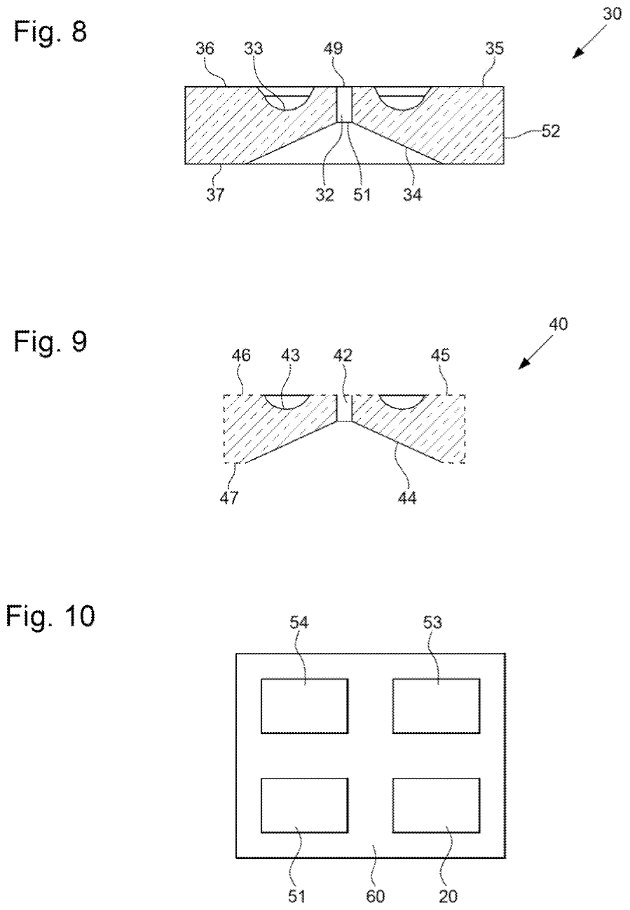

FIG. 8 shows the mineral body 30 after part of the machining step 11, during which the upper portion 48 of the dome 31 has been removed to obtain a through hole 32. The mineral body 30 is provided with the upper 36 and lower 37 faces which are of different shapes. Indeed, the lower face 37 has a conical shape bordering the hole 32, while the upper face 36 has a recess around the hole 32. Such a through hole 32 comprises a first opening 49 defined in the mineral body and opening into the lower face 37. The through hole 32 also comprises a second opening 51 defined in the mineral body 30 and opening into the upper face 36. Such a jewel has, for example, a thickness of 0.18 mm and a diameter of 0.8 mm, and a hole of diameter less than 0.1 mm. Such dimensions allow the use of very small diameter pivots. Preferably, the entire upper face 36 has the same height. Thus, the upper face 36 of the body is flat, outside the hole 32 and the recess 33. Material can also be removed from the circumferential surface 35, to obtain a desired jewel thickness.

The machining step 11 can also comprise a sub-step of planing the peripheral face 52 of the mineral body 30, in order to give it a determined diameter. The machining step 11 can also comprise a sub-step of planing the lower face 37, or even of widening or cutting the hole 32.

FIG. 9 shows an example of a jewel 40 obtained after all the steps of the method 10. Such a jewel 40 can be used as a guide element mounted in a bearing, such as that of FIG. 1. However, such a jewel cannot be limited to the watchmaking field and can be applied to any element movably mounted relative to a bearing, or to an industrial jewel (water jet nozzle, etc.), or a technical ceramic (insulator, etc.). The jewel 40 comprises the features described in the method above. The jewel 40 is traversed by a hole 42 intended to receive a pivot. The jewel 40 includes an upper surface 46 and a lower surface 47, one of which comprises a functional element, here a cone 44, communicating with the through hole 42. The upper face 36 comprises a recess 43 and the other side of the through hole 42. In other words, the hole 42 communicates with the upper face 46 and with the lower face 47.

Of course, the present invention is not limited to the example illustrated but is susceptible to various variations and modifications which will be apparent to the person skilled in the art. In particular, other types of functional elements formed during the pressing step can be advantageously considered according to the invention.

Referring to FIG. 10, the invention also relates to a jewel manufacturing system 60. This system 60 comprises the following various devices:
a device 51 for producing a precursor from a mixture of at least one powder material with a binder;
a device 20 for pressing the precursor material as defined above;
a device 53 for sintering said green body, and
a machine 54 for machining the body 30 of the future jewel 8 resulting from the sintering of the green body.

It will be noted that at least two of these devices 20, 51, 53 and 54 can together form the same entity of the system 60. Such a system 60 is capable of implementing the method for manufacturing the jewel 40 shown in FIG. 9, by going through the steps in FIG. 2.

1. A method (10) for manufacturing a poly-crystalline-type jewel (40), in particular for a timepiece, the jewel (40) comprising, for example, poly-ruby of the Al2O3Cr type or Zirconia of the ZrO2 type, the method comprising a first step (7) of producing a precursor (21), and a second step (8) of pressing the precursor (21) in order to form a body (30), the pressing (8) being carried out using a pressing device (20) provided with an upper die (22) and a lower die (16) defining a pressing space (25) wherein the precursor (21) is disposed, the upper die (22) comprising a concave portion (23) of oblong shape, the device being provided with a wire (17) at least partially traversing the lower die (16) to open into the pressing space (25), the lower die (16) being able to slide around the wire (17), the pressing (8) being carried out by bringing the lower die (16) and the upper die (22) closer together to form a body (30) comprising an upper face (36) provided with a dome (31) and a lower face (37) provided with a hole (32) extending at least partially into the dome (31).

2. The method according to claim 1, wherein the pressing (8) is carried out by displacing the lower die (16) towards the upper die (22).

3. The method according to claim 1, wherein during pressing (8), a circular recess (33) is formed in the upper face (36) of the body (30) around the dome (31), the upper die (22) being provided with a flange (24) delimiting the concave portion (23).

4. The method according to claim 1, wherein the upper die (22) displaces upwards under the effect of that of the lower die (16), the displacement of the upper die (22) being less than that of the lower die (16).

5. The method according to claim 1, wherein the method (10) comprises a third step of sintering (9) said body (30) in order to form a mineral body.

6. The method according to claim 5, wherein the method (10) comprises a fourth machining step (11) to remove an upper portion (48) of the dome (31) from the body (30), in order to obtain a through hole (32).

7. The method according to claim 6, wherein the method (10) comprises a fifth finishing step (12), for example a lapping and/or brushing and/or polishing of the mineral body.

8. A jewel (40), in particular for an horological movement, formed from a poly-crystalline-type body and comprising, for example, poly-ruby of Al2O3Cr type or Zirconia of ZrO2 type, the body (30) can be obtained by the method (10) according to claim 1, wherein the body (30) comprises a lower face (37) provided with a hole whose diameter is less than 0.11 mm, the body (30) comprising a dome (31) on the upper face (36), the hole (32) partly extending into the dome (31).

9. The jewel according to claim 8, wherein the diameter of the hole (32) is comprised within an interval ranging from 0.2 to 0.8 mm, or even from 0.4 to 0.6 mm.

10. The jewel according to claim 8, wherein the dome (31) forms an angle comprised within an interval ranging from 30° to 90°, preferably from 50 to 70°, or even 60°.

11. The jewel according to claim 8, wherein the hole (32) is a through hole, an upper portion (48) of the dome (31) being removed.

12. The jewel according to claim 8, wherein an upper face (36) of the body (30) comprises a circular recess (33) arranged around the hole (32).

13. The jewel according to claim 8, further comprising a flare (34) around the hole (32) on its lower face (37).

14. A timepiece, comprising a jewel according to claim 8, in particular for a bearing.

15. A pressing device (20) for manufacturing a jewel (30), in particular for a timepiece, the device (60) comprising an upper die (22) and a lower die (16) configured to be able to displace in a housing, the dies (16, 22) defining a pressing space (25) wherein a precursor (21) can be disposed, characterised in that the device (20) is provided with a wire (17) at least partially traversing the lower die (16) to open into the pressing space, the lower die (16) being able to slide around the wire (17), the upper die including a concave portion (23).
